(19) United States
(12) Patent Application Publication
(10) Pub. No.: US 2019/0003167 A1
(43) Pub. Date: Jan. 3, 2019

(54) NON-RETURN VALVE

(71) Applicant: Falcon Waterfree Technologies, LLC, Los Angeles, CA (US)

(72) Inventor: Edward Michael Goldsmith, Encino, CA (US)

(21) Appl. No.: 16/022,667

(22) Filed: Jun. 28, 2018

Related U.S. Application Data
(60) Provisional application No. 62/526,498, filed on Jun. 29, 2017.

(51) Int. Cl. E03C 1/298; F16K 15/14; B29C 45/00

(52) U.S. Cl. CPC E03C 1/298; B29L 2031/7506; B29C 45/006; F16K 15/147

(57) ABSTRACT

Described is a fluid control valve suitable to permit only gravitationally induced flow. The valve includes an inlet section in the form of a self-supporting trough-shaped section and an outlet section. The outlet section is formed from a flexible resilient material connected to the inlet section. The outlet section includes a sealing area with side gussets that hold a set of sealing surfaces of the sealing area apart from each other, where the sealing area is connected with the inlet section at its upper edge.

### CROSS-REFERENCE TO RELATED APPLICATIONS

This is a Non-Provisional patent application of U.S. Provisional Application No. 62/526,498, filed in the United States on Jun. 29, 2017, entitled, “Non-Return Valve,” the entirety of which is hereby incorporated by reference.

### BACKGROUND OF THE INVENTION

### (1) Field of Invention

The present invention relates to a fluid control valve and, more particularly, to a valve suitable to permit gravitationally induced flow only.

### (2) Description of Related Art

Fluid control valves are best for allowing liquid flow in one direction and preventing gaseous flow in the opposite direction. A prime application for such a valve is in drains of all kinds which are connected to the sewer system. Here it is necessary to permit flow through the valve into a sewer system while preventing reverse flow of malodorous gas in the reverse direction. This can be particularly useful in urinals in which the water trap has been removed, or in which regular flushing does not occur with each use.

Additionally, fluid control valves are often used to replace a liquid water seal, such as a trap found in floor drains or urinals. Examples of valves used in this type of application are flattened, flexible, and preferably resilient tubes extending from a wide inlet section. These were developed from drain-tube valves used in watercraft. The valves known to the applicant have been described in U.S. Pat. No. 6,401,266, Netherlands Patent No. NL 1015745C, EP 1174549, JP 49005434B, and JP 5090063 U.

Further, EP 1579133 discloses a duck bill valve having a sealing area with strips that flap freely and have no means to hold them open and away from each other. The resilient strip is separate from its opposing surface, which is a second strip. The two strips are separate and not connected and do not create a tubular structure. Thus, fluid is allowed to flow at the side of the sealing area.

Existing fluid control valves suffer from the build-up of deposits in the folds along the edges of the flattened tube where they are least resilient and the flat portions of the tubes connect to each other. This build-up is also difficult to remove because the narrowness of the valves in this area. Further, as the build-up develops, it opens the tube until a stage is reached where the valve no longer seals against a backflow of gas. This is highly undesirable in urinal applications of the valve. The known valve also suffers from an inward longitudinal collapse when exposed to high back pressure—as the valve is relatively flat and has little to no structure, due to the need for high flexibility.

Thus, a continuing need exists for a fluid control valve which will overcome the disadvantages set forth above and permit only gravitationally induced flow.

### SUMMARY OF INVENTION

The present invention relates to a fluid control valve and, more particularly, to a valve suitable to permit gravitationally induced flow only. The valve comprises an inlet section in the form of a self-supporting trough-shaped section, the inlet section having an upper edge; and an outlet section, the outlet section being made at least in part of a flexible resilient material connected to the inlet section. The outlet section comprises a sealing area, having a length, with side gussets that hold a set of sealing surfaces of the sealing area apart from each other, the sealing area being connected with the inlet section at its upper edge.

In another aspect, the valve further comprises a set of side walls, and wherein at least one side wall of the valve has a side gusset extending the length of the sealing area.

In another aspect, the side gussets are formed such that the sealing area of the valve can fully close and the set of side walls opposite the inlet are angled away from each other.

In another aspect, the valve comprises a peripheral outwardly extending supporting flange around the trough-shaped section.

In another aspect, a combination of the inlet trough-shaped section and the supporting flange allows the valve to maintain an open configuration.

In another aspect, the side gussets hold the sealing area open to increase a flow rate of the valve.

The invention further comprises a method for manufacturing a non-return valve. The method comprises acts of injecting elastomeric material into a mold to form an inlet section in the form of a self-supporting trough-shaped section, the inlet section having an upper edge, and an outlet section, the outlet section being made of a flexible resilient material connected to the inlet section, wherein the outlet section comprises a sealing area, having a length, with side gussets that hold a set of sealing surfaces of the sealing area apart from each other, the sealing area being connected with the inlet section at its upper edge.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a side-view illustration of a non-return valve according to embodiments of the present disclosure;

FIG. 2 is a side, cross-sectional view illustration of a non-return valve according to embodiments of the present disclosure;

FIG. 3 is a side-view illustration of a non-return valve with cross-section AA according to embodiments of the present disclosure; and

FIG. 4 is a front-view illustration of a non-return valve according to embodiments of the present disclosure.

### DETAILED DESCRIPTION

The present invention relates to a fluid control valve and, more particularly, to a valve suitable to permit gravitationally induced flow only. The following description is presented to enable one of ordinary skill in the art to make and use the invention and to incorporate it in the context of particular applications. Various modifications, as well as a variety of uses, in different applications will be readily apparent to those skilled in the art, and the general principles defined herein may be applied to a wide range of embodiments. Thus, the present invention is not intended to be limited to the embodiments presented, but is to be accorded with the widest scope consistent with the principles and novel features disclosed herein.

In the following detailed description, numerous specific details are set forth in order to provide a more thorough understanding of the present invention.

However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object. As such, as the present invention is changed, the above labels may change their orientation.

(1) Specific Details

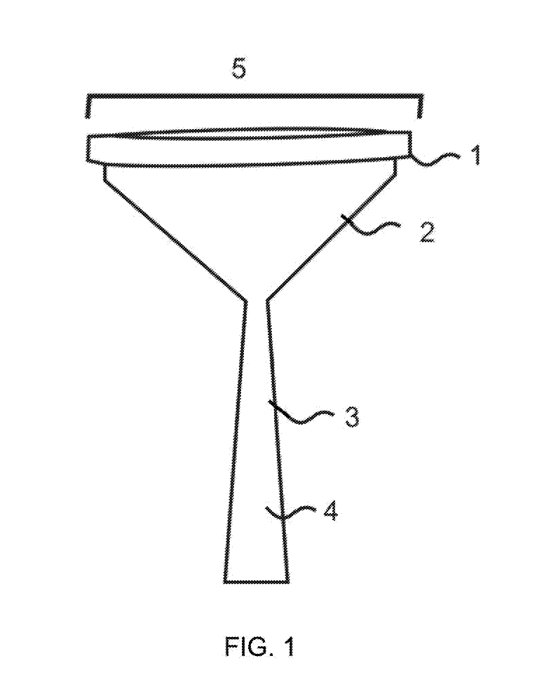

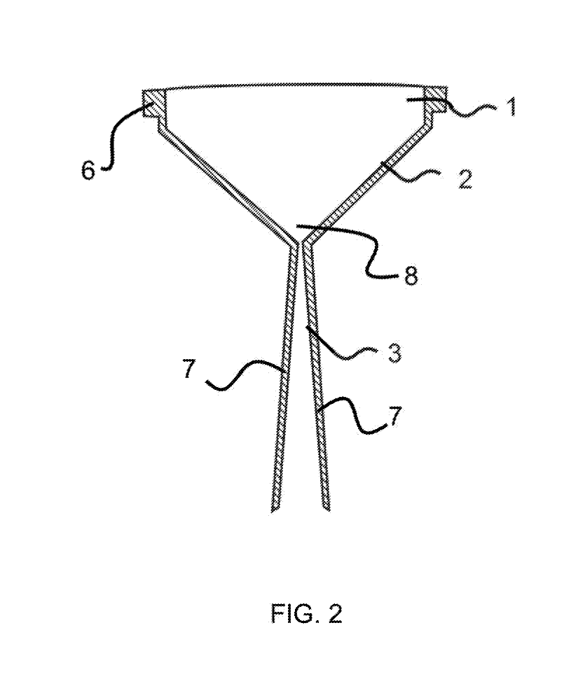

A urinal has an outlet connected to a sewerage system. In the outlet is fitted a duck-bill style non-return valve 5, as shown in FIG. 1, according to embodiments of the present disclosure. FIG. 1 is a side-view illustration of a non-return valve 5. The valve 5 is made from a suitable plastic or elastomeric material, such as silicone or high-density polyethylene (HDPE), with one end trough-shaped at an inlet section 1 having an edge and the other end as an elongated flexible resilient sealing area 3 with a high inherent degree of flexibility. In use, the sealing area 3 of the valve 5 can close against a reverse flow of gas from the sewerage system when placed in a drain. FIG. 2 is a side, cross-sectional view illustration of a non-return valve according to embodiments of the present disclosure.

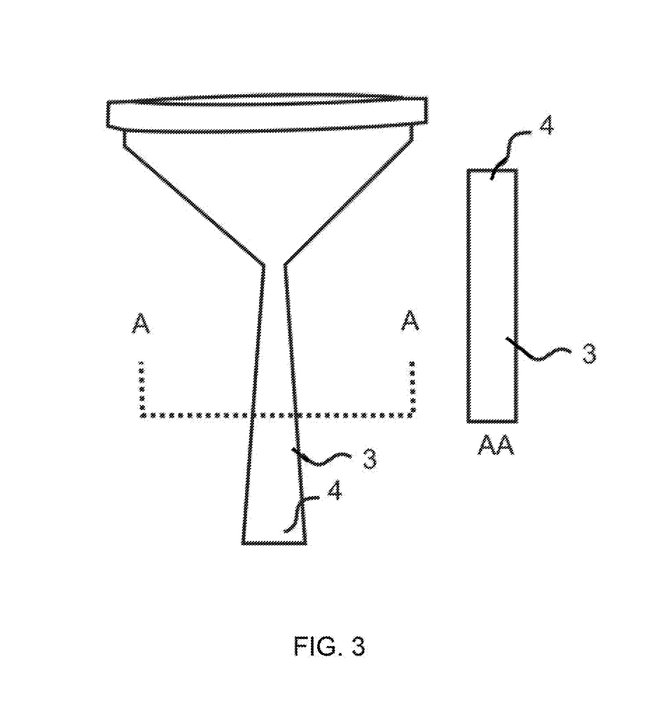

As described above, the valve 5 has a trough shaped inlet section 1 and a sealing area 3, which is substantially oval or rectangular in cross-section, as depicted in FIG. 3 (e.g., cross-section AA). Unlike existing valves that use two single strips that are separate and not connected and allow fluid to flow out the side of the sealing area 3, the valve 5 described herein has a closed cross-section made up of two sealing surfaces 7 (FIG. 2), and resilient side gussets in the side walls 4. The valve 5 is connected on the sides by side walls 4, creating a tubular structure. Sealing surfaces 7 (FIG. 2) are, thus, held apart for a section of the sealing area 3 by side walls 4. Importantly, that tubular structure is held open for at least a portion at its lower end rather than just being a flat tube.

In addition, unlike other prior art valves that have separate side strips, or a flat tubular shape in the sealing section, the valve 5 has two side wall 4 gussets, which hold the larger sealing surfaces 7 of the sealing area 3 away from each other, creating a larger cross-section for urine or fluids to flow through. This differentiates the valve from both types of prior art in an important way. For valves with independent strips like the ones found in EP1579133B1, the sealing surfaces created by separate strips are not held apart, slowing flow of urine and flushing water as the strips fluctuate and create friction, whereas the invention described herein holds these strips apart at rest, when there is no back pressure. For tubular valves like the ones from U.S. Pat. No. 6,401,266, which have a closed cross section, there is no side gusset, creating highly acute angles for urine solids to build up in, slowing flow, and creating friction for liquids to pass through. The side wall 4 gussets remove these acute angles of prior art valves that serve to catch and retain urine solids or debris from draining fluids.

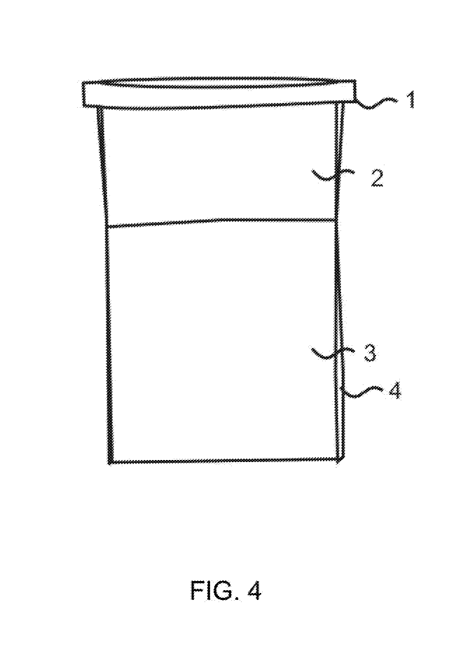

A peripheral outwardly extending supporting flange 6 (shown in FIG. 2) is provided around the outer ends of the self-supporting trough-shaped inlet section 1. This flange 6 is used to locate the valve 5 in the urinal outlet and serves to hold the valve 5 open, which is known by one skilled in the art of valve making. Rather than using lateral flow like the Dahm prior art valve, the present invention avoids buildup of solids materials by holding the sealing area 3 open with side wall 4 gussets. Thus, the construction becomes self-flushing in use. Side wall 4 gussets provide a second function which is to create an I beam structure which helps to prevent the valve 5 from collapsing longitudinally due to a sudden or significant change in pressure that can cause the thin and resilient surfaces of other valves to turn inside out and tangle. Additionally, the side wall 4 gussets being made of a flexible resilient material, can flex to allow the valve to close when receiving back pressure while still holding the valve open at rest for a substantial section of the sealing area 3 as shown in FIGS. 1-4. As shown in FIGS. 1-4, the side wall 4 gussets are formed such that the sealing area 3 of the valve 5 can fully close and the sealing surfaces 7 opposite the inlet section 1 are angled away from each other. This again has been a problem with earlier designs of urinal valves like those that have separate strips in the sealing area that can tangle under back pressure or fast flow. The side wall 4 gussets are made of a flexible resilient material, so they can flex and stretch when put under pressure to either open the valve further, or close the valve against back pressure from the sewer system. They are substantially perpendicular to each other and create side walls 4 (or gussets) to sealing surfaces 7.

The geometry of the trough shaped inlet section 1 of the invention described herein creates a structure in combination with the flange 6, allowing the valve 5 to maintain an open shape. The valve 5 is simple to install by removing the outlet cover grid from the outlet and inserting the valve 5 to position the flange 6 on the inner shoulder of the outlet. In one embodiment, an appropriate sealant will be used between the flange 6 and shoulder. The grid is then refitted into the outlet to complete the assembly.

In use, urine flows by gravity down the throat 8 of the valve 5 and into the sewer system. The flow of this liquid forms a small pressure difference on the outside of the tubular sealing section (sealing area 3), which has been found in practice to give a positive seal upstream of fluid as it passes through the valve 5. This seal prevents any malodorous gas from escaping by reverse flow through the valve. The side wall 4 gussets are gussets to the sealing surfaces 7 and hold the sealing area 3 open, increasing the flow rate of the valve 5 by reducing friction of the passing fluid. The valve 5 is inexpensive to manufacture and trials have shown it to be self-cleaning and, consequently, to have a long operative life.

While the valve 5 according to embodiments of the present disclosure has particular application to urinals, it will be appreciated by those skilled in the art that it can have other similar applications, and the components can be made of varying materials to meet such applications without departing from the scope of the invention as defined in the appended claims.

It will be readily apparent to persons skilled in the relevant arts that various modifications and improvements may be made to the foregoing embodiments, in addition to those already described, without departing from the basic inventive concepts of the present invention.

What is claimed is:

1. A non-return valve, the valve comprising:
an inlet section in the form of a self-supporting trough-shaped section, the inlet section having an upper edge; and
an outlet section, the outlet section being made at least in part of a flexible resilient material connected to the inlet section,
wherein the outlet section comprises a sealing area, having a length, with side gussets that hold a set of sealing surfaces of the sealing area apart from each other, the sealing area being connected with the inlet section at its upper edge.

2. The non-return valve as set forth in claim 1, wherein the valve further comprises a set of side walls, and wherein at least one side wall of the valve has a side gusset extending the length of the sealing area.

3. The non-return valve as set forth in claim 1, wherein the side gussets are formed such that the sealing area of the valve can fully close and the set of side walls opposite the inlet are angled away from each other.

4. The non-return valve as set forth in claim 1, further comprising a peripheral outwardly extending supporting flange around the trough-shaped section.

5. The non-return valve as set forth in claim 4, wherein a combination of the inlet trough-shaped section and the supporting flange allows the valve to maintain an open configuration.

6. The non-return valve as set forth in claim 1, wherein the side gussets hold the sealing area open to increase a flow rate of the valve.

7. A method for manufacturing a non-return valve, the method comprising acts of:
injecting elastomeric material into a mold to form an inlet section in the form of a self-supporting trough-shaped section, the inlet section having an upper edge, and an outlet section, the outlet section being made at least in part of a flexible resilient material connected to the inlet section, wherein the outlet section comprises a sealing area, having a length, with side gussets that hold a set of sealing surfaces of the sealing area apart from each other, the sealing area being connected with the inlet section at its upper edge.
